(19) United States
(12) Patent Application Publication
(10) Pub. No.: US 2006/0120542 A1
(43) Pub. Date: Jun. 8, 2006

(54) Flat panel output apparatus and method

(75) Inventors: Kyung-ju Lee, Gyeonggi-do (KR); Jeong-Seon Kim, Gyeonggi-do (KR); Valeri Toherniak, Gyeonggi-do (KR); Yang-sung Kim, Gyeonggi-do (KR); Young-hun An, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/254,752

(22) Filed: Oct. 21, 2005

(30) Foreign Application Priority Data
Oct. 22, 2004 (KR) 2004-0084760

(51) Int. Cl. H04R 25/00

(52) U.S. Cl. 381/152; 381/431

(57) ABSTRACT

The present invention relates to a flat panel audio output apparatus including a flat panel with a plurality of channel areas divided according to audio channels, with a division area separating the channel areas from each other to prevent vibrations between the channel areas from interfering with each other, and a plurality of vibrators provided in the respective channel areas, vibrating the respective channel areas to output sound based on audio signals provided to the vibrators corresponding to the audio channels. Thus, embodiments of the present invention provide a flat panel audio output apparatus and method, a video/audio output apparatus, and a flat panel audio output method, preventing sound quality from being deteriorated due to interference between sound output from a plurality of audio channels.

### CROSS-REFERENCE TO RELATED APPLICATIONS

This application claims the priority benefit of Korean Patent Application No. 2004-0084760, filed on Oct. 22, 2004, in the Korean Intellectual Property Office, the disclosure of which is incorporated herein by reference.

### BACKGROUND OF THE INVENTION

1. Field of the Invention

Embodiments of the present invention relate to a flat panel audio output apparatus and method, a video/audio output apparatus, and a flat panel audio output method. More particularly, embodiments of the present invention relate to a flat panel audio output apparatus and method, a video/audio output apparatus, and a flat panel audio output method that can prevent sound quality from being deteriorated due to interference between sound output from a plurality of audio channels.

2. Description of the Related Art

Generally, cone-type speakers have been widely used in outputting sound. The cone-type speaker include a cone made of paper, plastic, aluminum or the like, a flexible surround surrounding the rim of the cone, and a corrugated spider circumferentially surrounding the vertex of the cone.

However, recently, flat panel audio output apparatuses have been developed to output sound through a flat panel. Here, the flat panel audio output apparatus generates sound through a flat panel vibrated (or excited) by an exciter transforming an electric signal into mechanical vibration.

Thus, a flat panel audio output apparatus may include the flat panel generating sound and an exciter placed on the flat panel and vibrating the flat panel.

Generally, in the flat panel audio output apparatus, two exciters corresponding to two audio channels for a stereophonic sound are placed on a single flat panel. Therefore, each exciter vibrates the flat panel based on an electrical audio signal output from each audio channel, such that the flat panel is vibrated by an exciter corresponding to each audio channel, thereby generating multi-channel sound.

However, in the conventional flat panel audio output apparatus, because the respective exciters corresponding to the audio channels are provided on the same single flat panel, interference can arise between vibrations caused by the respective exciters corresponding to the audio channels.

FIG. 1 illustrates interference between vibrations from two audio channels in a conventional flat panel audio output apparatus 100. In the illustrated flat panel 110, of FIG. 1, ‘A’ indicates a sound position due to the vibration caused by a left exciter 120a, and ‘x’ indicates a sound position due to the vibration caused by a right exciter 120b.

Here, sound positions of the flat panel 110, vibrated by the respective exciters 120a and 120b, are distributed across the flat panel 110. Therefore, the flat panel 110 may include areas of interference, e.g., area A, where interference arises between separate vibrations caused by the respective exciters 120a and 120b.

Accordingly, the interference between the audio channels deteriorates the quality of sound output from the flat panel audio output apparatus 100. Accordingly, there is a need for the elimination of interference between the audio channels in the flat panel audio output apparatus 100.

### SUMMARY OF THE INVENTION

Accordingly, it is an aspect of the present invention to provide a flat panel audio output apparatus and method, a video/audio output apparatus, and a flat panel audio output method that can prevent sound quality from being deteriorated due to interference between sounds output from a plurality of audio channels.

To achieve the above and/or other aspects and advantages of the present invention, embodiments of the present invention include an audio output apparatus, including a panel comprising a plurality of channel areas, each corresponding to an audio channel, and a division area separating two channel areas to prevent vibrations between the two channel areas from interfering with each other, and at least one vibrator provided in each of the two channel areas, each vibrator separately vibrating respective channel areas to output sound based on respective audio signals provided to the at least one vibrator in each of the two audio channels.

The division area may have a vibration coefficient different from vibration coefficients of the two channel areas. In addition, the division area may include a hardener influencing the vibration coefficient of the division area to be different from vibration coefficients of the two channel areas.

The audio output apparatus may include a transparent conductor in the division area, and a power supply to supply power to the transparent conductor to influence the vibration coefficient of the division area be different from the vibration coefficients of the two channel areas.

The audio output apparatus may also include a supersonic generator to emit supersonic waves to the division area to prevent vibrations of the two channel areas from interfering with each other.

The audio output apparatus may include the panel being a flat panel.

To achieve the above and/or other aspects and advantages of the present invention, embodiments of the present invention include a video/audio output apparatus, including a panel display module to display a picture, a panel, facing the panel display module, comprising a plurality of channel areas, each corresponding to an audio channel, and a division area separating two channel areas to prevent vibrations between the two channel areas from interfering with each other, and at least one vibrator provided in each of the two channel areas, each vibrator separately vibrating respective channel areas to output sound based on respective audio signals provided to the at least one vibrator in each of the two audio channels.

The video/audio output apparatus may further include a damper interposed between flat panel display module and flat panel.

To achieve the above and/or other aspects and advantages of the present invention, embodiments of the present invention include a flat panel audio output method to output a sound, the method including adding a hardener to at least one of at least two transparent panels to separate the at least one transparent panel into two or more vibration insulating areas, and layering and heat-pressing the transparent panels to generate the two or more vibration insulating areas.

The at least one transparent panel may include a first area having the hardener and a second area having no hardener or a different hardener, such that a vibration coefficient of the first area is different from a vibration coefficient of the second area.

To achieve the above and/or other aspects and advantages of the present invention, embodiments of the present invention include an audio output method, including preventing vibrations between at least two channel areas from interfering with each other by separating the at least two channel areas in a panel, each channel area corresponding to an audio channel, through a division area to separate the two channel areas, and separately vibrating respective channels areas to output sound based on respective audio signals provided to at least one vibrator in each of the two audio channels.

The division area may have a vibration coefficient different from vibration coefficients of the two channel areas. In addition, the method may include supplying power to a conductor in the division area to influence a vibration coefficient of the division area be different from vibration coefficients of the two channel areas. Further, the method may include emitting supersonic waves to the division area to prevent vibrations of the two channel areas from interfering with each other.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 illustrates a conventional flat panel audio output apparatus;

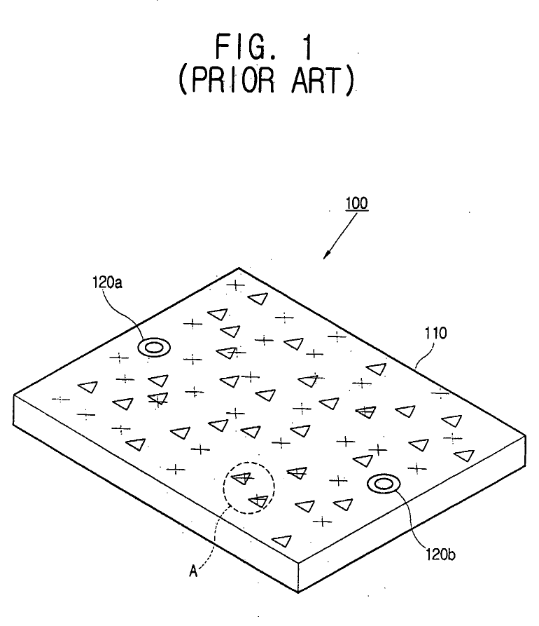

FIG. 2 illustrates a schematic exploded perspective view of a video/audio output apparatus, according to an embodiment of the present invention;

FIG. 3 illustrates a block diagram of a video/audio output apparatus, according to an embodiment of the present invention;

FIG. 4 illustrates a flat panel audio output apparatus, according to another embodiment of the present invention;

FIG. 5A illustrates vibration characteristics of a conventional flat panel audio output apparatus;

FIG. 5B illustrates vibration characteristics of a flat panel audio output, apparatus according to an embodiment of the present invention;

FIG. 6 illustrates a flat panel audio output apparatus, according to another embodiment of the present invention;

FIG. 7 illustrates a flat panel audio output method, according to an embodiment of the present invention; and

FIG. 8 illustrates a flat panel audio output apparatus, according to another embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout. Embodiments are described below in order to explain the present invention by referring to the figures.

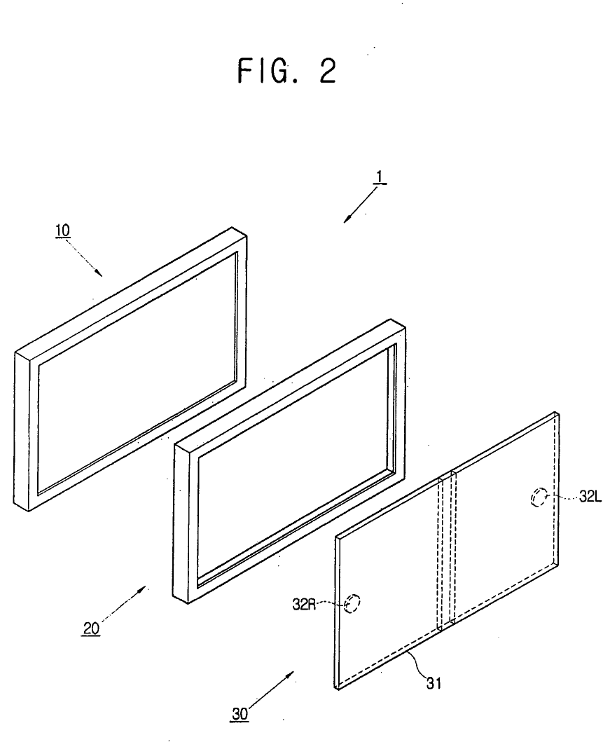

FIG. 2 illustrates a schematic exploded perspective view of a video/audio output apparatus 1, according to an embodiment of the present invention. As shown in FIG. 2, the video/audio output apparatus 1 may include a flat panel display module 10 and a flat panel audio output apparatus 30. Further, the video/audio output apparatus 1 may further include a damper 20 between the flat panel display module 10 and a flat panel 31.

By way of example, the video/audio output apparatus 1 will be considered below as having two audio channels for outputting a stereophonic sound, noting that embodiments of the present invention are not limited thereto. Further, ‘flat’, as used herein, is a relative term and should not be construed as reflecting perfect flatness.

The flat panel display module 10 may display a picture based on a video signal processed by a predetermined process. According to an embodiment of the present invention, the flat panel display module 10 may include one of various type display modules. such as a liquid crystal display (LCD) module, a plasma display panel (PDP) module, an organic light emitting diode (OLED) module, etc, noting that additional embodiments are not limited thereto.

The flat panel audio output apparatus 30 may include the flat panel 31 and exciters 32R and 32L.

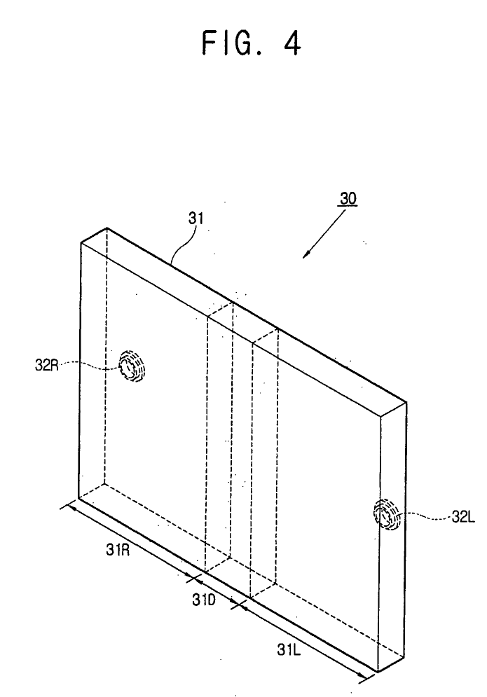

The flat panel 31 can be vibrated by the exciters 32R and 32L, thereby generating sound. According to an embodiment of the present invention, the flat panel 31 may include a first channel area 31R outputting sound for a first audio channel, a second channel area 31L outputting sound for a second audio channel, and a division area 31D separating the flat panel 31 between the first channel area 31R and the second channel area 31L, as illustrated in FIG. 4.

Here, the first channel area 31R and the second channel area 31L can be used for outputting the right channel and the left channel of the stereophonic sound, respectively.

The division area 31D separates the flat panel 31 between the first channel area 31R and the second channel area 31L, thereby preventing interference between vibrations of the first channel area 31R and the second channel area 31L. Thus, the vibrations of the first channel area 31R and the second channel area 31L do not interfere with each other, such that the first channel sound and the second channel sound are output independently of each other, thereby improving the quality of the multi channel sound, e.g., a stereo sound. Here, various further embodiments of with division area 31D will be described below.

As shown in FIG. 2, the first channel area 31R and the second channel area 31L can be provided with the exciters 32R and 32L, respectively. Hereinafter, the exciter provided in the first channel area 31R will be referred to as the first exciter 32R, and the exciter provided in the second channel area 31L will be referred to as the second exciter 32L. Further, the first channel area 31R and the second channel area 31L can be provided with additional exciters.

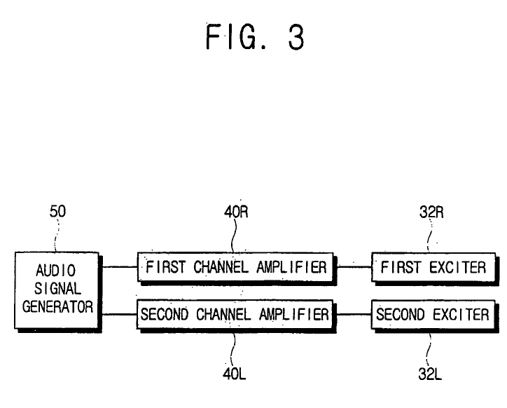

As shown in FIG. 3, the first exciter 32R can vibrate the first channel area 31R of the flat panel 31, according to a first channel analog audio signal output from an audio signal generator 50 and amplified by a first channel amplifier 40R. Thus, the first channel area 31R can output a first channel sound through the vibration caused by the first exciter 32R.

Further, the second exciter 32L can vibrate the second channel area 31L of the flat panel 31, according to a second channel analog audio signal output from the audio signal generator 50 and amplified by a second channel amplifier 40L. Thus, the second channel area 31L can output a second channel sound through the vibration caused by the second exciter 32L.

Here, the audio signal generator 50 can have various configurations as long as it can perform similar functions as the output of the first and second channel analog audio signals to the first and second channel amplifiers 40R and 40L, respectively. For example, in the case where the flat panel audio output apparatus 30 is implemented in a portable computer, the audio signal generator 50 may include a data reproducer such as an optical disc drive, e.g., a compact disc (CD) drive, a digital video disc (DVD) drive, etc., to reproduce and output sound data, such as music files stored in a CD, a DVD, a hard disk drive, or the like. The audio signal generator may further include a reproducing program and a digital/analog converter to convert a digital audio signal reproduced by a reproducing process to generate the first and second channel analog audio signals and output the generated signals to the first and second channel amplifiers 40R and 40L.

FIG. 4 illustrates the flat panel 31 of the flat panel audio output apparatus 30, according to an embodiment of the present invention. As shown in FIG. 4, the flat panel 31 may include the first channel area 31R, the second channel area 31L, and the division area 31D.

Here, the division area 31D can have a vibration coefficient different from vibration coefficients of the first and second channel areas 31R and 31L. Thus, vibrations in the first and second channel areas 31R and 31L, caused by first and second exciters 31, respectively, are not transferred to the opposing channel areas, thereby preventing vibrations between the first and second channel areas 31R and 31L from interfering with each other.

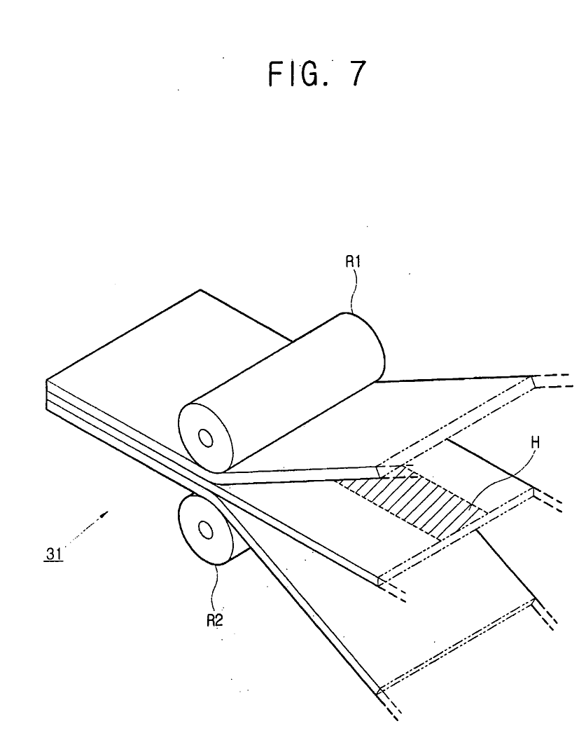

According to an embodiment of the present invention, the division area 31D can be made of materials containing a hardener H, as illustrated in FIG. 7, so that the division area 31D has a vibration coefficient different from respective vibration coefficients of the first and second channel areas 31R and 31L. Here, the hardener H may vary according to the materials of the flat panel 31, as long as the hardener can have a vibration coefficient different from the respective vibration coefficients of the first and second channel areas 31R and 31L. For example, when the flat panel 31 is made of a transparent acrylic material, epoxy resin may be used as the hardener H. Here, the epoxy resin may include amine or polyamide.

In addition, the hardener H may have the same light transmissivity as the flat panel 31. The hardener H may also have a light transmissivity of 100%.

Thus, vibration from the first exciter 32R and the vibrations from the second exciter 32L can be canceled out in the division area 31D, such that the first and second channel areas 31R and 31L respectively vibrate independently of each other. Therefore, the first and second channel areas 31R and 31L, respectively, output sounds corresponding to the first and second audio channels, independently of each other, thereby improving the sound quality corresponding to each of the multi audio channels.

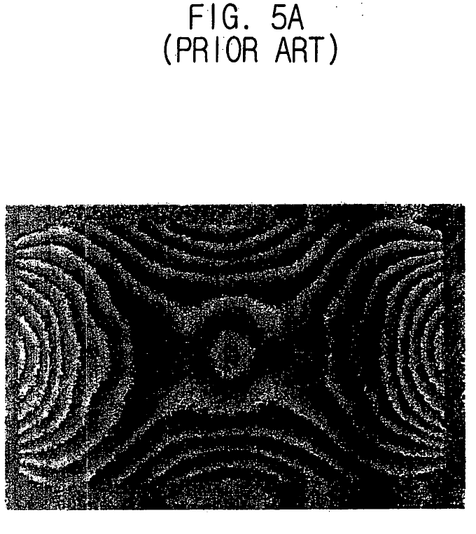

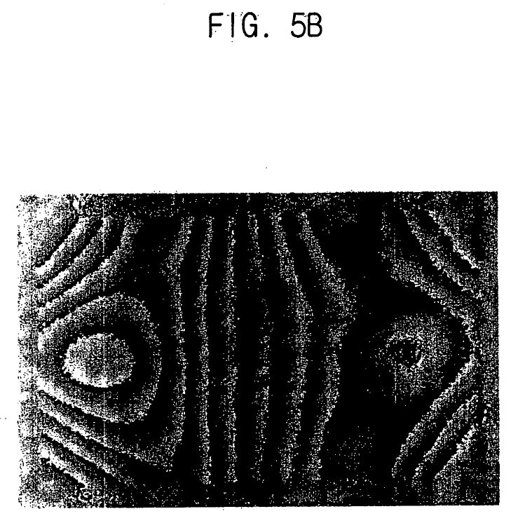

FIG. 5A illustrates vibration characteristics of a conventional flat panel audio output apparatus, where two exciters are provided on the flat panel and vibrate the flat panel to output sounds corresponding to two audio channels. Conversely, FIG. 5B illustrates vibration characteristics of the flat panel audio output apparatus according to an embodiment of the present invention, where the first and second exciters 32R and 32L are provided on the flat panel 31 and vibrate the flat panel 31 to output sounds corresponding to first and second audio channels.

As compared with FIG. 5A, FIG. 5B illustrates that vibrations of the first and second channel areas 31R and 31L do not interfere with each other, because of the division area 31D in the flat panel audio output apparatus 30.

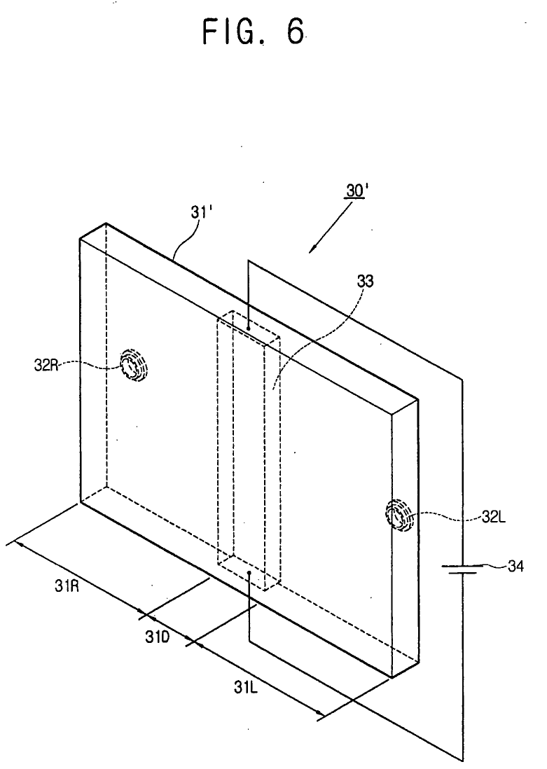

FIG. 6 illustrates a flat panel audio output apparatus 30′ according to an embodiment of the present invention. As shown in FIG. 6, in the flat panel audio output apparatus 30′, a flat panel 31′ may include a first channel area 31R, a second channel area 31L, and a division area 31D.

The flat panel audio output apparatus 30′ may include a transparent conductor 33 provided in the division area 31D, and may further include a power supply 34 to supply power to the transparent conductor 33.

When the power is supplied from the power supply 34 to the transparent conductor 33, an electrical characteristic and the vibration coefficient of the transparent conductor 33 may be changed. Thus, the vibration coefficient of the division area 31D, provided with the transparent conductor 33, may become different from the vibration coefficients of the first and second channel areas 31R and 31L.

FIG. 7 illustrates a flat panel audio output method, according to an embodiment of the present invention. As shown in FIG. 7, the flat panel 31 may include an applied hardener H to a portion of at least one of two or more transparent panels to generate the division area 31D, with a heating/pressing of the two or more transparent panels, by heated rollers R1 and R2, to generate the first channel area 31R, the second channel area 31L, and the division area 31D.

In FIG. 7, as an example, three transparent panels may be heated and pressed, with the hardener H being added to an intermediate transparent panel. Alternatively, the flat panel 31 may include an added hardener H to at least one of two transparent panels. Further, the flat panel 31 may also include four or more transparent panels using a similar method.

Conversely, using the flat panel 31′ as an example, according to another embodiment of the present invention, the flat panel 31′ may include an inserted transparent conductor 33, into a portion of a panel, corresponding to the portion that is applied with the hardener H illustrated in FIG. 7.

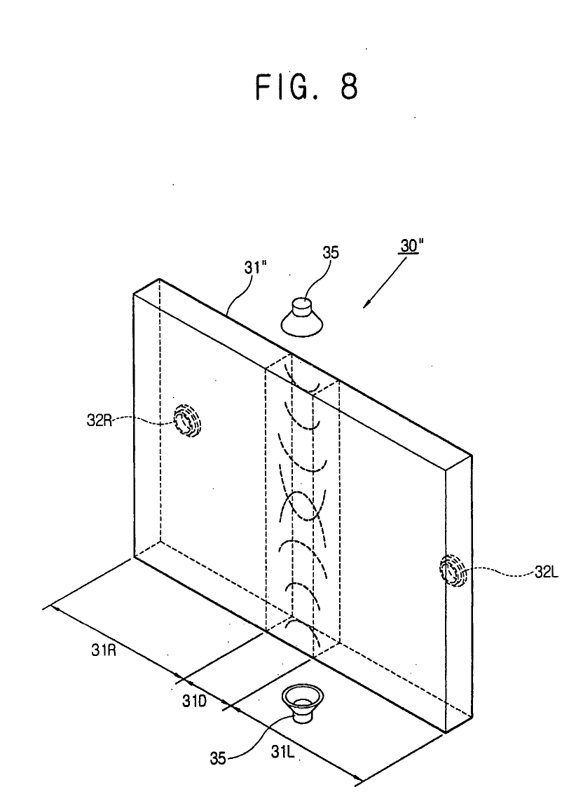

FIG. 8 illustrates a flat panel audio output apparatus, according to another embodiment of the present invention. As shown therein, a flat panel audio output apparatus 30″ may include a supersonic generator 35 to generate supersonic waves in/toward the division area 31D.

When the supersonic waves are emitted in/toward the division area 31D, the division area 31D can be vibrated by the supersonic waves. Accordingly, vibrations of the first and second channel areas 31R and 31L, vibrated by first and second exciters 32R and 32L, can be canceled by the vibration in the division area 31D, such that the vibrations of the first and second channel areas 31R and 31L do not interfere with each other. Thus, the first and second channel areas 31R and 31L can respectively output sound, corresponding to the first and second audio channels, independently of each other, thereby improving the sound quality in each the multi audio channel.

In the foregoing, the flat panel audio output apparatuses 30, 30′, 30″ have been illustrated as having two audio channels for stereophonic sound only as examples. Alternatively, the flat panel 31, 31′, 31″, of the respective flat panel audio output apparatus 30, 30′, 30″, may include three or more channel areas and exciters corresponding to respective channel areas, wherein the vibrations of the respective channel areas do not interfere with each other.

Further, the video/audio output apparatus 1, according to an embodiment of the present invention, may include various apparatuses, e.g., they may display a picture and generate sound using the foregoing flat panel audio output apparatuses 30, 30′, 30″. For example, the video/audio output apparatus 1, according to an embodiment of the present invention, may include a monitor, a television, a portable computer, a mobile phone, a personal digital assistant (PDA), or the like.

Further, in the foregoing embodiment, an exciter has been illustrated as being employed to vibrate the flat panel 31, 31′, 31″. However, such a vibration generator is not limited to an exciter and may vary as long as it can vibrate the flat panel 31, 31′, 31″ based on the audio signal generated from the audio signal generator 50. For example, the vibration generator may include various actuators such as a piezoelectric actuator, which can vibrate the flat panel 31, 31′, 31″ to make sound, noting that additional embodiments are equally available.

Further, the division area 31D of the flat panel 31, 31′, 31″ may be formed as discussed above, but is not limited thereto and may be formed by any combination of the same, as well as through other implementations.

Therefore, according to embodiments of the present invention, there is provided a flat panel including a plurality of channel areas corresponding to audio channels, and a division area to divide the flat panel into the plurality of channel areas, thereby preventing vibrations from the channel areas from interfering with each other. A plurality of exciters may be respectively placed in the plurality of channel areas of the flat panel and vibrate the plurality of channel areas to output sounds corresponding to the audio channels. Here, a flat panel audio output apparatus and a video/audio output apparatus enhance sound quality by preventing sound from being deteriorated due to interference between sounds output from a plurality of audio channels.

As described above, embodiments of the present invention provides a flat panel audio output apparatus and method, a video/audio output apparatus, and a flat panel method, which can prevent sound quality from being deteriorated due to interference between sound output from a plurality of audio channels.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An audio output apparatus, comprising:
a panel comprising a plurality of channel areas, each corresponding to an audio channel, and a division area separating two channel areas to prevent vibrations between the two channel areas from interfering with each other; and
at least one vibrator provided in each of the two channel areas, each vibrator separately vibrating respective channel areas to output sound based on respective audio signals provided to the at least one vibrator in each of the two audio channels.

2. The audio output apparatus of claim 1, wherein the division area has a vibration coefficient different from vibration coefficients of the two channel areas.

3. The audio output apparatus of claim 2, wherein the division area includes a hardener influencing the vibration coefficient of the division area to be different from vibration coefficients of the two channel areas.

4. The audio output apparatus of claim 3, further comprising:
a transparent conductor in the division area; and
a power supply to supply power to the transparent conductor to influence the vibration coefficient of the division area be different from the vibration coefficients of the two channel areas.

5. The audio output apparatus of claim 2, further comprising:
a transparent conductor in the division area; and
a power supply to supply power to the transparent conductor to influence the vibration coefficient of the division area to be different from the vibration coefficients of the two channel areas.

6. The audio output apparatus of claim 1, further comprising a supersonic generator to emit supersonic waves to the division area to prevent vibrations of the two channel areas from interfering with each other.

7. The audio output apparatus of claim 3, further comprising a supersonic generator to emit supersonic waves to the division area to prevent vibrations of the two channel areas from interfering with each other.

8. The audio output apparatus of claim 5, further comprising a supersonic generator to emit supersonic waves to the division area to prevent vibrations of the two channel areas from interfering with each other.

9. The audio output apparatus of claim 1, wherein the panel is a flat panel.

10. A video/audio output apparatus, comprising:
a panel display module to display a picture;
a panel, facing the panel display module, comprising a plurality of channel areas, each corresponding to an audio channel, and a division area separating two channel areas to prevent vibrations between the two channel areas from interfering with each other; and
at least one vibrator provided in each of the two channel areas, each vibrator separately vibrating respective channel areas to output sound based on respective audio signals provided to the at least one vibrator in each of the two audio channels.

11. The video/audio output apparatus of claim 10, wherein the panel is a flat panel.

12. The video/audio output apparatus of claim 10, wherein the division area has a vibration coefficient different from vibration coefficients of the two channel areas.

13. The video/audio output apparatus of claim 12, wherein the division area includes a hardener influencing the vibration coefficient of the division area to be different from vibration coefficients of the two channel areas.

14. The video/audio output apparatus of claim 13, further comprising:
a transparent conductor in the division area; and
a power supply to supply power to the transparent conductor to influence the vibration coefficient of the division area be different from the vibration coefficients of the two channel areas.

15. The video/audio output apparatus of claim 12, further comprising:
a transparent conductor in the division area; and
a power supply to supply power to the transparent conductor to influence the vibration coefficient of the division area be different from the vibration coefficients of the two channel areas.

16. The video/audio output apparatus of claim 10, further comprising a supersonic generator to emit supersonic waves to the division area to prevent vibrations of the two channel areas from interfering with each other.

17. The video/audio output apparatus of claim 16, further comprising a damper interposed between the panel display module and flat panel.

18. A flat panel audio output method to output a sound, the method comprising:
adding a hardener to at least one of at least two transparent panels to separate the at least one transparent panel into two or more vibration insulating areas; and
layering and heat-pressing the transparent panels to generate the two or more vibration insulating areas.

19. The method of claim 18, wherein the at least one transparent panel comprises a first area having the hardener and a second area having no hardener or a different hardener, such that a vibration coefficient of the first area is different from a vibration coefficient of the second area.

20. An audio output method, comprising:
preventing vibrations between at least two channel areas from interfering with each other by separating the at least two channel areas in a panel, each channel area corresponding to an audio channel, through a division area to separate the two channel areas; and
separately vibrating respective channels areas to output sound based on respective audio signals provided to at least one vibrator in each of the two audio channels.

21. The method of claim 20, wherein the division area has a vibration coefficient different from vibration coefficients of the two channel areas.

22. The method of claim 20, further comprising supplying power to a conductor in the division area to influence a vibration coefficient of the division area be different from vibration coefficients of the two channel areas.

23. The method of claim 20, further comprising emitting supersonic waves to the division area to prevent vibrations of the two channel areas from interfering with each other.
